(19) United States
(12) Patent Application Publication
(10) Pub. No.: US 2015/0106608 A1
(43) Pub. Date: Apr. 16, 2015

(54) POWER-ON SCHEDULING OF MULTIPLE BLADES REQUIRING A PREBOOT IMAGE FROM A REMOTE DISK

(71) Applicant: International Business Machines Corporation, Armonk, NY (US)

(72) Inventors: Jimmie L. Brundidge, Raleigh, NC (US); William G. Pagan, Durham, NC (US); Carlos Santana, Durham, NC (US); Tiviley W. Slack, Raleigh, NC (US)

(73) Assignee: International Business Machines Corporation, Armonk, NY (US)

(21) Appl. No.: 14/052,119

(22) Filed: Oct. 11, 2013

Related U.S. Application Data
(63) Continuation of application No. 14/050,456, filed on Oct. 10, 2013.

(51) Int. Cl. G06F 9/44; G06F 1/26

(52) U.S. Cl. CPC G06F 9/4416; G06F 1/26
USPC 713/2

(57) ABSTRACT

A method includes obtaining an inventory of hardware devices in each of a plurality of blades, and calculating, for each of the plurality of blades, an amount of boot time to power-on the blade and reach a condition in which the blade is ready to receive a preboot image, wherein the amount of boot time is calculated as a function of the inventory of hardware devices in the blade. In addition, a preboot image load time is identified for each of the plurality of blades. The method then further comprises scheduling power-on of each of the plurality of blades so that a subsequent blade in an order is ready to mount the remote disk and receive the preboot image when a previous blade in the order has received the preboot image and released the remote disk.

### CROSS-REFERENCE TO RELATED APPLICATIONS

This application is a continuation of U.S. patent application Ser. No. 14/050,456 filed on Oct. 10, 2013, which application is incorporated by reference herein.

### BACKGROUND

1. Field of the Invention

The present invention relates to booting multiple blades using a preboot image stored on a remote disk.

2. Background of the Related Art

Large computer systems may include hundreds or thousands of compute nodes that run various application programs to meet the objectives of a large entity or numerous individuals. These compute nodes may be variously configured to support operation, maintenance and power-on of the compute nodes. In one configuration, an advanced management module (AMM) provides management services to coordinate the use of the compute nodes. Furthermore, a group of compute nodes or blades may be operated efficiently in a multi-blade chassis that provide various support services to the group of compute nodes. A multi-blade chassis or blade chassis may include a chassis management module (CMM) that controls and communicates with the compute nodes within a particular chassis, and further communicates with the AMM. The AMM may control and communicate with the CMM in any number of multi-blade chassis.

In some configurations, the AMM provides a remote disk that stores a preboot image to be used by each of the blades. However, the remote disk function for a blade chassis only allows 50 MB to be remotely mounted at a given time. And this 50 MB must be shared by all of the blades in the multi-blade chassis, which typically accommodates up to 14 blades at one time. Due to this limitation, all 14 blades are unable to access the 30 MB-40 MB preboot image at the same time. Accordingly, one blade at a time is powered on and mounts the remote disk until completing its boot process and moving to the next blade. However, booting a single blade can take as much as 8 to 10 minutes.

### BRIEF SUMMARY

One embodiment of the present invention provides a method, comprising obtaining an inventory of hardware devices in each of a plurality of blades, and calculating, for each of the plurality of blades, an amount of boot time to power-on the blade and reach a condition in which the blade is ready to receive a preboot image, wherein the amount of boot time is calculated as a function of the inventory of hardware devices in the blade. In addition, a preboot image load time is identified for each of the plurality of blades. The method then further comprises scheduling power-on of each of the plurality of blades so that a subsequent blade in an order is ready to mount the remote disk and receive the preboot image when a previous blade in the order has received the preboot image and released the remote disk.

### BRIEF DESCRIPTION OF THE SEVERAL VIEWS OF THE DRAWINGS

FIG. 1 is a diagram of a computer system including a remote management module in communication with the chassis management module of multiple multi-blade chassis.

FIG. 2A is a table illustrating an inventory of hardware devices in a blade.

FIG. 2B is a table of system state data.

FIG. 3 is a table illustrating the POST time, system state and preboot load time for each of four blades.

FIG. 4 is a timeline illustrating a power-on schedule that makes efficient use of the remote disk.

FIG. 5 is a diagram of a computer according to one embodiment of a remote management module.

FIG. 6 is a flowchart of a method in accordance with one embodiment of the present invention.

### DETAILED DESCRIPTION

One embodiment of the present invention provides a method, comprising obtaining an inventory of hardware devices in each of a plurality of blades, and calculating, for each of the plurality of blades, an amount of boot time to power-on the blade and reach a condition in which the blade is ready to receive a preboot image, wherein the amount of boot time is calculated as a function of the inventory of hardware devices in the blade. In addition, a preboot image load time is identified for each of the plurality of blades. The method then further comprises scheduling power-on of each of the plurality of blades so that a subsequent blade in an order is ready to mount the remote disk and receive the preboot image when a previous blade in the order has received the preboot image and released the remote disk.

Embodiments of the invention deal with a plurality of blades that need access to a limited shared resource in order to complete a boot process. For example, each of the plurality of blades being powered on may require a preboot image that is stored on a single remote disk. The present invention provides methods of efficiently sharing the remote disk and allowing the plurality of blades to boot without undue delay.

The method obtains an inventory of the devices within each blade, such as the number and type of any expansion adapters (i.e., storage adapters or network adapters) and UEFI firmware level. For example, a management application running on the AMM may send a request to a management module on a multi-blade chassis to collect a device inventory for all of the blades within the chassis. The AMM receives the device inventory for each blade that it manages and may, for example, store the device inventory information. Alternatively, the AMM may immediately use the device inventory to determine a boot time or boot time contribution without storing the device inventory.

The device inventory is used to calculate the amount of time (i.e., POST time) that a blade will require to get from its current power state (ON or OFF) to completing the BOOT POST. A blade will typically go through memory initialization, UEFI boot completion, device components ROM startup completion before completing BOOT POST. Using the amount of POST time determined to be required by each blade, the method may then determine the appropriate time to start the power-on sequence for each blade in order to make optimal use of the remote disk capability. A power-on schedule may identify a time to initiate the power-on of each computer in order make optimal use of access to the remote disk. The remote disk capability includes the data transfer rate from the remote disk.

Where a blade's system state is already OFF, the boot time is the same as the POST time. However, embodiments of the invention may consider and include additional time required due to the current system state being ON. Accordingly, boot time is preferably the sum of the POST time and any additional time necessary to shutdown the blade from its current system state.

The following xml is a snippet of a device characterization file for the HX5 blade server to calculate boot times:

<DeviceCharacter>
<DeviceType>HX5</DeviceType>
<BootTimes>
<Entry>
<Name>POST</Name>
<Time>180</Time>
</Entry>
<Entry>
<Name>PREBOOT IMAGE</Name> <!-- PREBOOT IMAGE boot
time -->
<Time>682</Time>
</Entry>
<Entry>
<Name>UEFI</Name> <!-- Power on to UEFI Boot -->
<Time>82</Time>
</Entry>
<Entry>
<Name>Legacy</Name> <!-- Power on to Legacy Boot -->
<Time>245</Time>
</Entry>
<Entry>
<Name>RAM</Name> <!-- Per gigabyte of installed RAM Time -->
<Time>unknown</Time>
</Entry>
<Entry>
<Name>Expansion Emulex VFA</Name> <!-- Expansion Emulex VFA
Boot Time -->
<Time>unknown</Time>
<Entry>
<Name>Expansion Qlogic CAN</Name> <!-- Expansion Qlogic CAN
Boot Time -->
<Time>unknown</Time>
</Entry>
</BootTimes>
.....

The solution presented makes use of the xml for storing boot times for particular device characteristics. As new firmware and new hardware is presented, the xml is updated to reflect the boot time change of those devices.

A device inventory for each blade may be obtained when a setup program, such as IBM FastSetup, is launched against a blade chassis. For example, an AMM may run the setup program to obtain a device inventory for each blade in a blade chassis connected for communication with the AMM. The device inventory should have vital information for each blade, such as a current power-on state of the blade, an amount of memory in the blade, the type of adapters included in the blade, firmware levels and other vital information that will make a difference in the boot time for the blade. For example, a blade may have a hardware device that will affect the time to complete the UEFI Initialization, and therefore extends the boot time for that blade. In a specific example, the blade may have a QLogic network adapter that requires 15 seconds to complete the UEFI Initialization. Based on this information, there is no need to for the blade to mount the remote disk until this 15 second period has expired.

In a further embodiment, the inventory of hardware devices identifies a capacity of at least one hardware device in the blade, wherein the calculation of boot time includes the capacity multiplied by a time factor. Accordingly, the method may provide a time factor for various types of devices, such as an amount of time for each MB of RAM, such that multiplying the time factor by the capacity reflects the amount of boot time attributable to the hardware device having the identified capacity. For example, the inventory of hardware devices may identify an amount of memory in the blade.

In a still further embodiment, the inventory of hardware devices may identify a type of at least one hardware device in the blade, wherein the calculation of boot time includes a predetermined amount of time for the identified type of hardware device. Therefore, the method may include a lookup table having a predetermined amount of boot time that is attributable to a hardware device of the given type. For example, the inventory of hardware devices may identify a type of a network adapter in the blade.

The current system state of each blade may also be considered in determining the boot time for each blade. For example, a blade that is in the OFF state is generally ready to access and use the remote disk in a shorter amount of time than a similarly configured blade that is in the ON state and running an operating system. Therefore, a blade in the OFF state may be placed earlier in a boot order than a blade that is in the ON state. This is particularly true for selecting a blade that will be first in the boot order, since a blade in the OFF state can be ready to access the remote disk quicker and allow use of the remote disk to being earlier.

According to one embodiment, the method may further comprise identifying a current system state of each of the plurality of blades, wherein calculating, for each of the plurality of blades, an amount of boot time to power-on the blade and reach a condition in which the blade is ready to receive a preboot image, includes determining an amount of time to shutdown the blade in response to identifying that the current system state of the blade is powered-on, and adding the amount of time to shutdown the blade into the boot time for the blade. Optionally, an amount of time to shutdown the blade may be determined as a function of the hardware inventory for the blade. In an alternative option, the amount of time to shutdown the blade is a predetermined amount of time.

The method may then calculate a boot time (i.e., how long it will take for a blade to get from its current state to the point where it is ready for a preboot image) for each blade based upon the blade's current power state and device inventory. The calculated boot time may then be used to determine when to power-on (or power-off/power-on) each blade in order to stagger the point at which each blade will make use of the remote disk presence to load a preboot image.

In an alternative embodiment, the plurality of blades are received in a multi-blade chassis. For example, the plurality of blades may be blade servers, and the multi-blade chassis may include a chassis management module. Accordingly, obtaining an inventory of hardware devices in each of a plurality of blades, may include the chassis management module obtaining an inventory of hardware devices from each of the plurality of blade servers and reporting the inventory of hardware devices for each of the plurality of blade servers to a remote management module.

In order to provide the preboot image to each blade at the point that each blade is ready, the method controls the power-on times of the blades so that the blades are ready at different times. In other words, the method controls the power-on times of the blades so that the blades stagger their use of a remote disk that stores the preboot image (i.e., the limited resource). Preferably, the method determines and implements a power-on schedule, such that each subsequent blade in a sequence is ready to receive a boot image from the remote disk just as each previous blade in the sequence finishes loading the boot image and releases the remote disk. Optionally, the power-on schedule may provide performance booting for all of the blades in a particular blade chassis.

The method may further determine the amount of time it will take each blade to load the preboot image from the remote disk (the “preboot image load time”). During this time period, the blade will need to maintain access to the remote disk, such that other blades will not be able to access or receive the preboot image. The load time may be a function of a size of the preboot image and a data transfer rate from the remote disk. The data transfer rate may be limited by the speed of the remote disk or by the available bandwidth of a bus used to transfer the preboot image to the blades. In one embodiment, the load time may be calculated by dividing the size of the preboot image (i.e., MB) by the data transfer rate (MB/second). While the method may calculate a unique load time for each blade, it may also be a reasonable approximation to use the same preboot image load time for each of the plurality of blades.

The power-on schedule preferably will place the blade having the shortest boot time to be first in the order of the plurality of blades to mount the remote disk storing the boot image. Starting the power-on schedule with the blade having the shortest boot time will allow the remote disk (the limited resource) usage to begin at the earliest possible time. Depending upon the range of boot times determined for the plurality of blades, the order of the remaining blades may not be important. However, the second and subsequent blades to mount the remote disk should have short enough boot times that they are ready to mount the remote disk and receive the preboot image when the first blade releases the remote disk, or as soon as possible thereafter. Optionally, the blades may be scheduled in an order of ascending boot times, so that the next blade in the order will always be, from among the blades still needing the receive the preboot image, the blade with the shortest boot time and the most likely to be ready to receive the preboot image when the previous blade releases the remote disk.

It should be recognized that the “order” discussed in relation to the power-on schedule, is the order of mounting the remote disk, not the order of power-on. Once the order of blades to mount the remote disk has been determined, the power-on schedule is determined by back calculating the power-on time for each particular blade so that the particular blade will be ready to receive the preboot image (i.e., has completed boot POST) when the previous blade has released the remote disk. Accordingly, a first blade having a very long boot time might power-on prior to a second blade having a very short boot time, even if the second blade will received the preboot image before the first blade.

When the power-on schedule is implemented, the method instructs each blade when to power on. When an individual blade is ready to receive a boot image, such as immediately after the individual blade has completing the boot POST, then that individual blade will check to see if the remote disk is available to mount. If the remote disk is being used by another blade, then the individual blade must wait. Once the remote disk has been released by the other blade, the individual blade is able to mount the remote disk and begin to receive the boot image. For example, the remote disk accessible to the AMM provides the preboot image to the individual blade, which stores the preboot image for use by the Unified Extensible Firmware Interface (UEFI) of the individual blade. The preboot image may include, without limitation, an operating system, utilities and diagnostics, boot and data recovery information or other data.

Another embodiment of the present invention provides a computer program product including computer readable program code embodied on a computer readable storage medium. The computer program product comprises: computer readable program code for obtaining an inventory of hardware devices in each of a plurality of blades; computer readable program code for calculating, for each of the plurality of blades, an amount of boot time to power-on the blade and reach a condition in which the blade is ready to receive a preboot image, wherein the amount of boot time is calculated as a function of the inventory of hardware devices in the blade; computer readable program code for identifying a preboot image load time for each of the plurality of blades; and computer readable program code for scheduling power-on of each of the plurality of blades so that a subsequent blade in the order is ready to mount the remote disk and receive the preboot image when a previous blade in the order has received the preboot image and released the remote disk.

The foregoing computer program product may further include computer readable program code for implementing or initiating any one or more aspects of the methods described herein. Accordingly, a separate description of the methods will not be duplicated in the context of a computer program product.

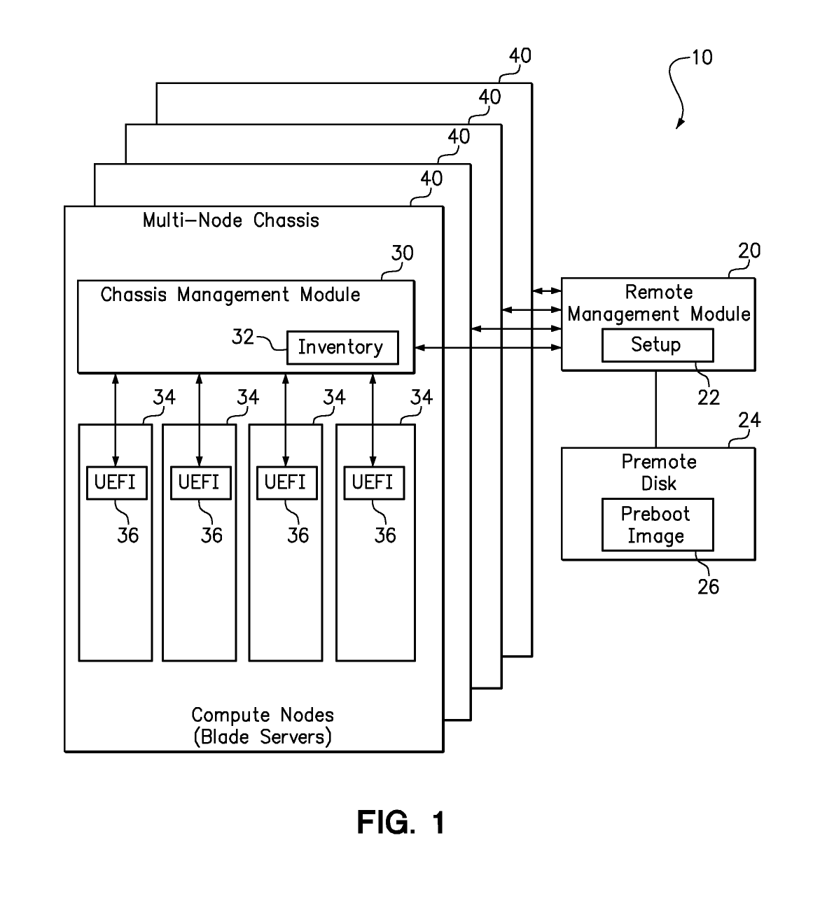

FIG. 1 is a diagram of a computer system 10 including a remote management module 20 in communication with the chassis management module 30 of a multi-blade chassis 40. In this diagram, the remote management module 20 is in communication with four multi-blade chassis 40, but only one of the multi-blade chassis is shown in detail.

The remote management module 20 includes a setup program 22 that implements the methods of the present invention. A remote disk 24 is accessible to the remote management module 20 and stores a preboot image 26. The preboot image 26 is needed by each of the blades in the multi-blade chassis 40 as part of the boot process and the remote disk 24 is shared by the blades. In one example, the remote disk function for a blade or blade only allows 50 MB to be remotely mounted at a given time, and the 50 MB must be shared by all blades. When the preboot image is 40 MB, only one of the blades is able to use the remote disk at any one time.

Each multi-blade chassis 40 includes a chassis management module 30 that, among other functions, gathers an inventory 32 of hardware devices in each of the blades 34. Each blade 34 has a Unified Extensible Firmware Interface (UEFI) 36 that is in communication with the chassis management module 30. Optionally, the blades 34 are blade servers and the multi-blade chassis 40 is a blade server chassis, which can typically include as many as fourteen blade servers (only four shown). The communication between the chassis management module 30 and the UEFI 36 of each blade 34 allows the chassis management module 30 to obtain the inventory 32 that identifies certain hardware devices within each of the blades 34. Furthermore, the communication between the chassis management module 30 and the UEFI 36 of each blade 34 allows the remote management module 20 to send the preboot image 26 from the remote disk 24 to the UEFI 36 of each blade 34 via the chassis management module 30.

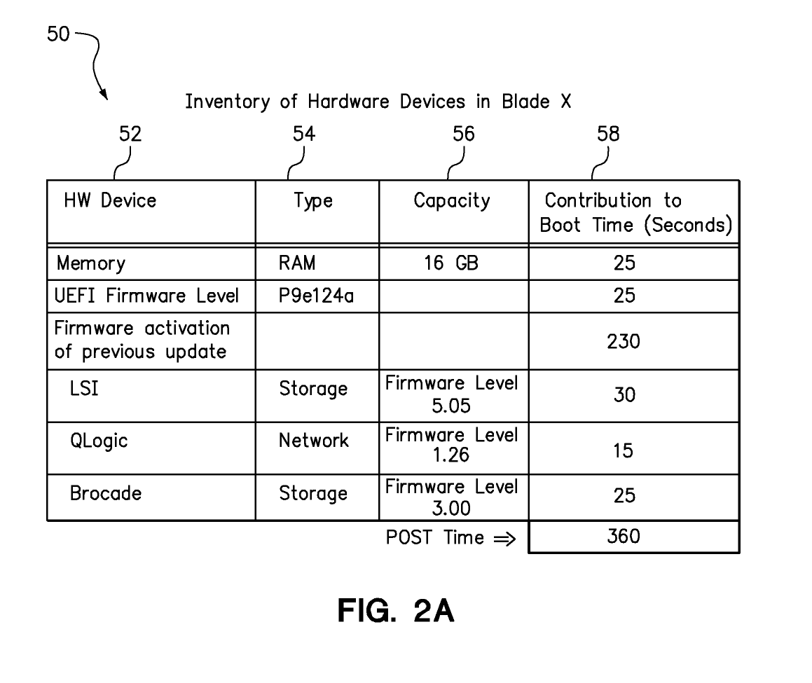

FIG. 2A is a table 50 illustrating an inventory of hardware devices in one of the blades 34 shown in FIG. 1. The information shown in the table, for example, may be stored as part of the inventory 32 shown in FIG. 1, along with the inventory of hardware devices in each of the blades 34 within the same multi-blade chassis 40. In the table 50, the blade is shown to include various hardware devices identified in the first column 52. The hardware devices identified in the inventory 50 need not be comprehensive of all hardware in the blade. Rather, each blade may have certain hardware devices that cause a difference in the amount of time it takes for the blade to reach a point where it can use the remote disk and receive the preboot image. Accordingly, the inventory 50 may focus on identifying a small subset of hardware devices that have the greatest effect on the boot time. As a result, the blade inventory 50 is shown to have memory, UEFI firmware, firmware activation of a previous update, a network adapter, and two storage adapters. For each hardware device identified in the first column 52, the type may be identified in the second column 54, the capacity may be identified in the third column 56, and the contribution to boot time may be calculated and set out in column 58. Some hardware devices may contribute a fixed amount of boot time based upon their type, while other hardware devices may contribute a marginal amount of boot time for each unit of capacity. These rules and factors are maintained by the setup logic of the remote management module. The total of all of the hardware device's contribution to boot time provides an estimate of the amount of time the blade will require to proceed from a powered-off state to be ready to receive the preboot image.

For example, the inventory may identify that the blade is a blade server having a particular model identification, such as HX5, HS23, HS22, and HS22V. The model identifications may be associated with a predetermined amount of time that is necessary to initialize its UEFI before reaching the setup screen. These predetermined amounts may be stored for access by the setup logic of the remote management module. The inventory will preferably also identify the type and amount of memory in each blade, the amount of firmware, the type of any expansion card and the time necessary to initialized boot rom for the expansion card, and the type and link speed of network adapters.

FIG. 2B is a table 51 of system state data. Although not part of the inventory, certain embodiments of the invention may also detect and consider the system state of the blade in determining a boot time, since it takes longer to shut down the operating system properly and restart the system than to power-on a blade that is already powered-off. The system state is computed based on the power state (ON or OFF) of the blade and the type of operating system which is running. As shown, the table 51 shows a power state (column 53), an OS type (column 55), an OS name/version (column 57), an amount of time before the blade is ready to begin POST (column 59).

In one example, if the blade characterized by the hardware inventory of FIG. 2A (POST time of 360 seconds) is powered-on with a Windows 2008 R2 operating system (additional time of 45 seconds), then the boot time is determined to be 405 seconds.

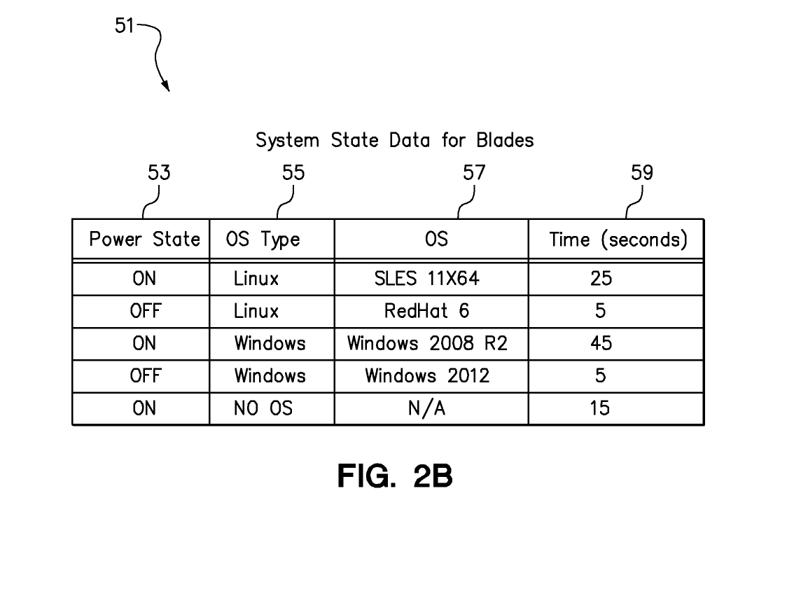

FIG. 3 is a table 60 illustrating, for each blade (first column 62), the POST time (second column 64), system state (third column 66), and preboot load time (fourth column 68) for each of four blades. Note that the POST time (column 64) for each blade is different, reflecting that the four blades (Blade 1-4) do not have identical hardware configurations. The system state (column 66) shows that each of the blades is “off”, such that no additional time is necessary to shutdown on of the blades. In other words, since no additional time is needed to shutdown the blade, the boot time (the sum of column 64 and column 66) will be the same as the POST time. Still further, the preboot load time for each blade is shown (column 68) is shown as a predetermined amount of time (i.e., 2 minutes).

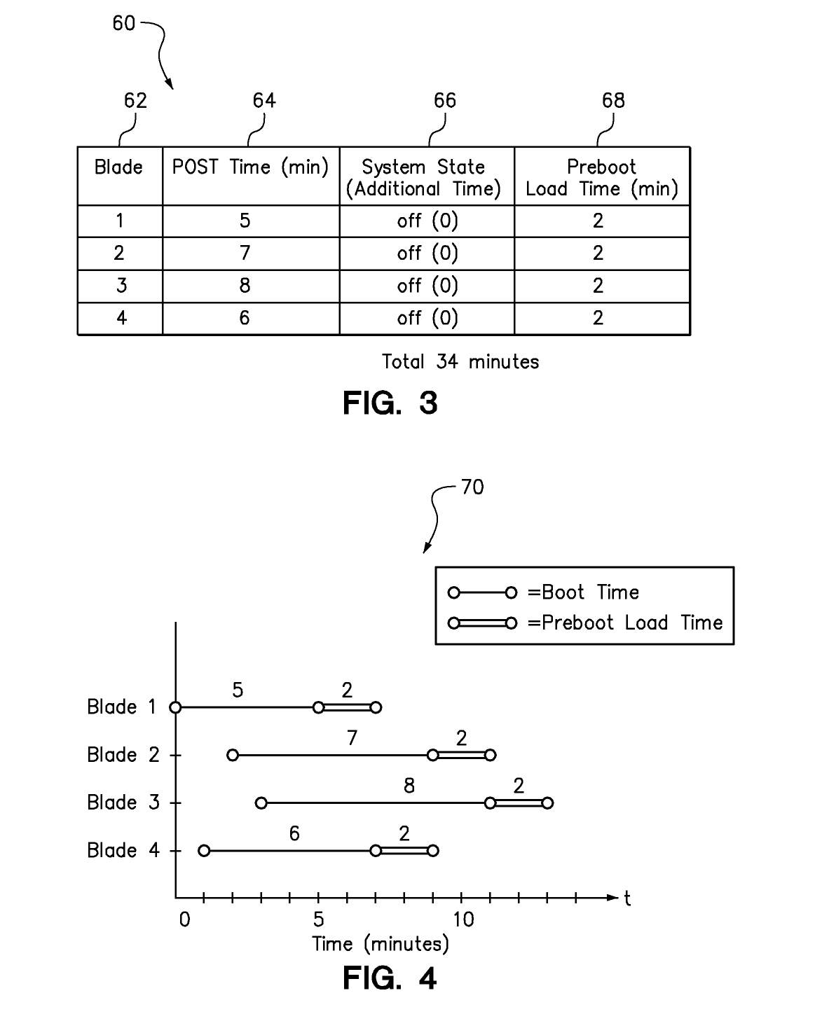

FIG. 4 is a power-on schedule 70 in the form of a timeline that makes efficient use of the remote disk. The power-on schedule 70 is consistent with the data from the table 60 of FIG. 3. This first blade to mount the remote disk is Blade 1, since it has the shortest boot time of 5 minutes. None of the other blades is able to make use of the remote disk that soon. Notice that since each blade is assumed to have a preboot load time of 2 minutes, Blade 1 will release the remote disk after 7 minutes. While Blade 3 has a boot time of 8 minutes and cannot be ready to its preboot image when Blade 1 releases the remote disk, either of Blade 2 and Blade 4 are candidates to be the second blade to mount the remote disk. However, in the embodiment shown, the blades are allowed to mount the remote disk in an ascending order of boot time, such that Blade 4 is second in the order, Blade 2 is third in the order and Blade 3 is fourth in the order. For purpose of discussion, if Blade 4 had been in a system state of “ON” and required 3 additional minutes to shutdown, then the order would have been Blade 1, Blade 2, Blade 3, and then Blade 4. In the illustration shown, as well as the foregoing additional situation, the remote disk is continuously used from the 5 minute mark to the 13 minute mark, such that the group of 4 blades all have received their preboot images within 13 minutes after beginning the setup process by powering-on Blade 1. Furthermore, the power-on-schedule reflects that blades are powered on as follows: Blade 1 at time 0 minutes, Blade 4 at time 1 minutes, Blade 2 at time 2 minutes, and Blade 3 at time 3 minutes. While this example shows the order of mounting the remote disk is the same as the power-on order, a broader range of boot times could easily result in one order to mounting the remote disk and another order for powering-on the blades.

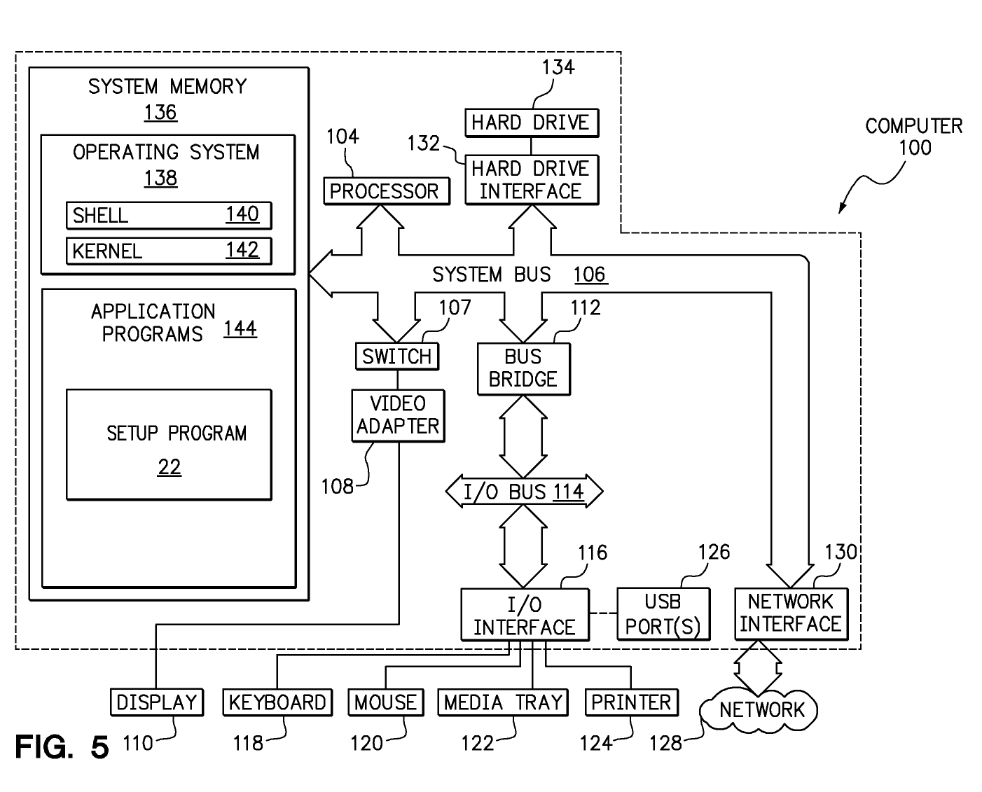

FIG. 5 is a diagram of an exemplary computing node or blade (or simply “computer”) 100 that may be utilized in accordance with one or more embodiments of the present invention. Note that some or all of the exemplary architecture, including both depicted hardware and software, shown for and within computer 100 may be implemented in the remote management module 20 as shown in FIG. 1.

Computer 100 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in a preferred embodiment some or all of these ports are universal serial bus (USB) ports.

As depicted, the computer 100 is able to communicate over a network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 100. This volatile memory includes additional higher levels of volatile memory (not shown), including, but not limited to, cache memory, registers and buffers. Data that populates system memory 136 includes computer 100's operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management. Application programs 144 in the system memory of computer 100 may include a setup program 22 for implementing the methods described herein. Furthermore, the hard drive 134 may serve as the remote disk 24 storing the preboot image 26 as shown in FIG. 1.

The hardware elements depicted in computer 100 are not intended to be exhaustive, but rather are representative components suitable to perform the processes of the present invention. For instance, computer 100 may include alternate memory storage devices such as magnetic cassettes, digital versatile disks (DVDs), Bernoulli cartridges, and the like. These and other variations are intended to be within the spirit and scope of the present invention.

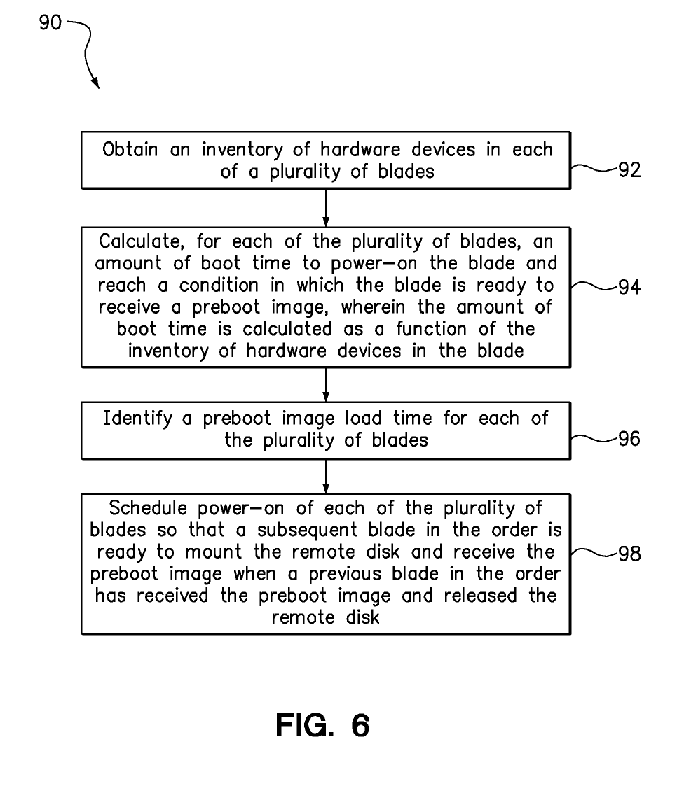

FIG. 6 is a flowchart of a method 90 in accordance with one embodiment of the present invention. In step 92, the method obtains an inventory of hardware devices in each of a plurality of blades. In step 94, the method calculates, for each of the plurality of blades, an amount of boot time to power-on the blade and reach a condition in which the blade is ready to receive a preboot image, wherein the amount of boot time is calculated as a function of the inventory of hardware devices in the blade. A preboot image load time for each of the plurality of blades is identified in step 96. Then, in step 98, each power-on of each of the plurality of blades is scheduled so that a subsequent blade in the order is ready to mount the remote disk and receive the preboot image when a previous blade in the order has received the preboot image and released the remote disk.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
obtaining an inventory of hardware devices in each of a plurality of blades;
calculating, for each of the plurality of blades, an amount of boot time to power-on the blade and reach a condition in which the blade is ready to receive a preboot image, wherein the amount of boot time is calculated as a function of the inventory of hardware devices in the blade;
identifying a preboot image load time for each of the plurality of blades; and
scheduling power-on of each of the plurality of blades so that a subsequent blade in the order is ready to mount the remote disk and receive the preboot image when a previous blade in the order has received the preboot image and released the remote disk.

2. The method of claim 1, wherein the blade is ready to receive a preboot image upon completion of the boot power-on-self-test (POST).

3. The method of claim 1, wherein a blade of the plurality of blades having the shortest boot time is placed first in the order of the plurality of blades to mount the remote disk storing the boot image.

4. The method of claim 1, wherein the plurality of blades are scheduled to mount the remote disk in an order of ascending boot time.

5. The method of claim 1, wherein identifying a preboot image load time for each of the plurality of blades, includes identifying a size of the preboot image, identifying a data transfer rate from the remote disk, and dividing the size by the data transfer rate.

6. The method of claim 5, wherein the same preboot image load time is used for each of the plurality of blades.

7. The method of claim 1, wherein the plurality of blades are received in a multi-blade chassis.

8. The method of claim 7, wherein the plurality of blades are blade servers, and the multi-blade chassis include a chassis management module.

9. The method of claim 8, wherein obtaining an inventory of hardware devices in each of a plurality of blades, includes the chassis management module obtaining an inventory of hardware devices from each of the plurality of blade servers and reporting the inventory of hardware devices for each of the plurality of blade servers to a remote management module.

10. The method of claim 1, wherein the inventory of hardware devices identifies a capacity of at least one hardware device in the blade, and wherein the calculation of boot time includes the capacity multiplied by a time factor.

11. The method of claim 10, wherein the inventory of hardware devices identifies an amount of memory in the blade.

12. The method of claim 1, wherein the inventory of hardware devices identifies a type of at least one hardware device in the blade, and wherein the calculation of boot time includes a predetermined amount of time for the identified type of hardware device.

13. The method of claim 12, wherein the inventory of hardware devices identifies a type of a network adapter in the blade.

14. The method of claim 1, further comprising:
identifying a current system state of each of the plurality of blades; and
wherein calculating, for each of the plurality of blades, an amount of boot time to power-on the blade and reach a condition in which the blade is ready to receive a preboot image, includes determining an amount of time to shutdown the blade in response to identifying that the current system state of the blade is powered-on, and adding the amount of time to shutdown the blade into the boot time for the blade.

15. The method of claim 14, wherein determining an amount of time to shutdown the blade is a function of the hardware inventory for the blade.

16. The method of claim 14, wherein the amount of time to shutdown the blade is a predetermined amount of time.
